(19) United States
(12) Patent Application Publication
(10) Pub. No.: US 2014/0188565 A1
(43) Pub. Date: Jul. 3, 2014

(54) CUSTOMER DEMOGRAPHIC DATA CHANGE DETECTION BASED ON MONITORED UTILITY CONSUMPTION

(71) Applicant: INTERNATIONAL BUSINESS MACHINES CORPORATION, Armonk, NY (US)

(72) Inventors: Patrick Dantressangle, Hampshire (GB); Eberhard Hechler, Sindelfingen (DE); Martin A. Oberhofer, Bondorf (DE); Michael Wurst, Stuttgart (DE)

(73) Assignee: INTERNATIONAL BUSINESS MACHINES CORPORATION, Armonk, NY (US)

(21) Appl. No.: 13/781,387

(22) Filed: Feb. 28, 2013

Related U.S. Application Data
(63) Continuation of application No. 13/728,868, filed on Dec. 27, 2012.

(51) Int. Cl. G06Q 30/02

(52) U.S. Cl. CPC G06Q 30/0201
USPC 705/7.33; 705/7.29

(57) ABSTRACT

In general, the present disclosure describes techniques for detecting changes in demographic data of a customer based on energy consumption data of the customer. For example, a customer data management system receives energy consumption data of a customer and detects, based at least in part on the received energy consumption data of the customer, a change in demographic data associated with the customer. The customer data management system then outputs, based at least in part on the detecting, at least one demographic change report associated with the demographic data.

This application is a continuation of Ser. No. 13/728,868, filed on Dec. 27, 2012, entitled CUSTOMER DEMOGRAPHIC DATA CHANGE DETECTION BASED ON MONITORED UTILITY CONSUMPTION, the entire content of which is incorporated herein by reference.

### BACKGROUND

Utility companies and other service providers such as telecommunications companies or internet service providers regularly rely on customer data to tailor services and advertisements in an attempt to better meet customer needs. Having up-to-date data about customers is important for marketing, customer relationship management, billing, and fraud detection. Such customer data may include contract data, such as the opening and closing of accounts, payments, and service changes, as well as demographic data, such as marital status, age, number of residents, or occupation.

Customer data may also include data indicating the energy consumption of the customer. Some service providers receive and store energy consumption data from customers using various techniques. Energy consumption data can be used to assess billing charges, or determine stress loads within a provider network (e.g., power grids). For example, power companies may receive energy consumption data via electrical meters which monitor the consumption of electrical energy. Some power companies may use smart meters, which are able to transmit consumption rate information to the power company. Such smart meter data may be measurements taken by the smart meter at frequent intervals, such as every 30 minutes. The smart meter may transmit smart metering data to the power company on a regular basis (e.g., daily) via wired and/or wireless networks.

While service providers and utility companies may obtain smart metering data and contract data, maintaining accurate demographic data is more difficult. In order to obtain demographic data, some companies will regularly send letters randomly to customers, asking as to any changes in the customer's demographic status. However, customers usually have little incentive to provide such information, so the number of responses received can be considerably small while the mailings may be considerably costly.

### SUMMARY

Techniques are described for detecting potential changes in the demographic data of a customer by analysis of received energy consumption data or usage data of a utility. The techniques may, for example, receive energy consumption data from smart meters associated with various customers and receive changes or updates in demographic data from a subset of the customers. The techniques may, for example, create a model based on the received energy consumption data and known changes to the demographic data for the subset of the customers, and then detect potential changes in demographic data for other customers based at least in part on the energy consumption data associated with those customers. In some examples, the model may be created using clustering. In some examples, techniques may be applied to consumption of electrical power by the customers. In other examples, usage data corresponding to other utilities such as water, telecommunications, or Internet service may be used as a basis for the model.

In one example, techniques of the present disclosure are directed to a computer-implemented method. The method may include receiving energy consumption data of a customer, detecting, based at least in part on the received energy consumption data of the customer, a potential change in demographic data associated with the customer, and outputting, based at least in part on the detecting, at least one demographic change report associated with the demographic data.

In another example, techniques of the present disclosure are direct to a customer data management system. The customer data management system may include one or more processors. The customer data management system may include an application server operable by the one or more processors to receive consumption data of a customer and detect, based at least in part on the received consumption data of the customer, a potential change in demographic data associated with the customer. The customer data management system may include an input/output server operable by the one or more processors to output, based at least in part on the detecting, at least one demographic change report associated with the demographic data.

In another example, techniques of the present disclosure are directed to a computer program product. The computer program product may include one or more computer-readable tangible storage devices, and program instructions, stored on at least one of the one or more computer-readable tangible storage devices, to receive energy consumption data of a customer, detect, based at least in part on the received energy consumption data of the customer, a potential change in demographic data associated with the customer, and output, based at least in part on the detecting, at least one demographic change report associated with the demographic data.

The details of one or more aspects of this disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system for detecting and reporting a potential change in demographic data, in accordance with one or more aspects of the present disclosure.

FIG. 2 is a block diagram illustrating further details of one example implementation of the customer data management system illustrated in FIG. 1, in accordance with one or more aspects of the present disclosure.

FIGS. 3A, 3B, and 3C are block diagrams illustrating an example process for mapping usage data, in accordance with one or more aspects of the present disclosure.

FIGS. 4A, 4B, and 4C are block diagrams illustrating an example process for detecting a potential change in demographic data, in accordance with one or more aspects of the present disclosure.

FIG. 5 is a flowchart illustrating an example process for detecting and reporting a potential change in demographic data, in accordance with one or more aspects of the present disclosure.

### DETAILED DESCRIPTION

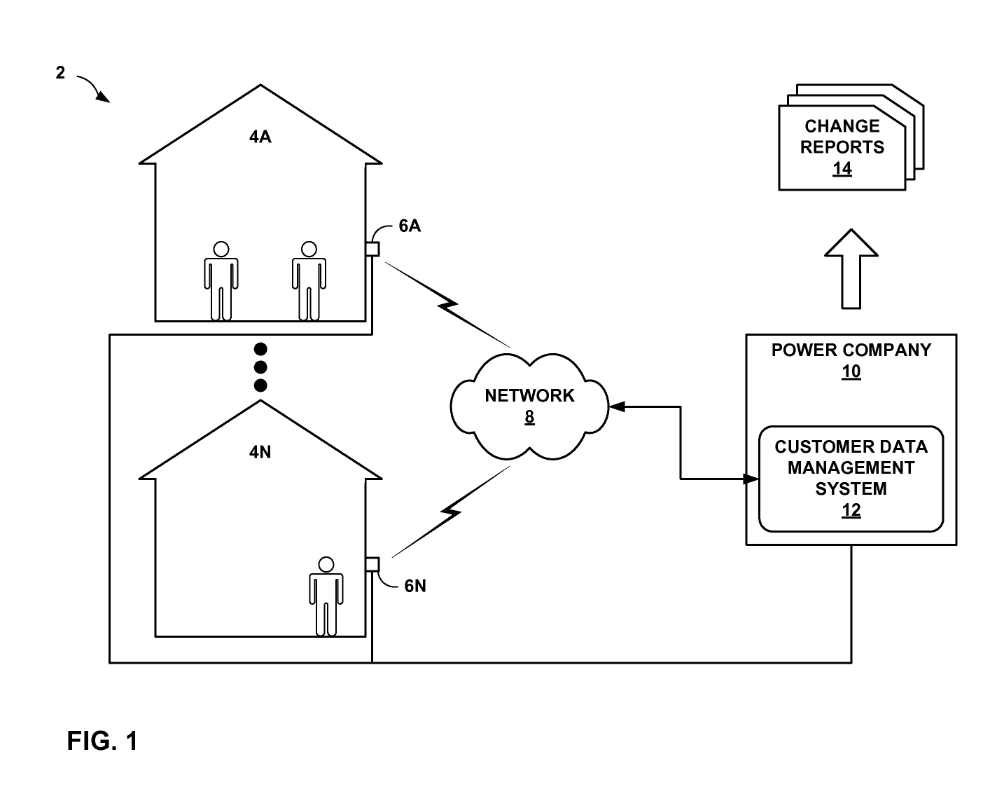

FIG. 1 is a block diagram illustrating an example system 2 for detecting and reporting a potential change in demographic data, in accordance with one or more aspects of the present disclosure. System 2 may include a plurality of customer households 4A-4N (collectively “households 4”), associated smart meters 6A-6N (collectively “smart meters 6”), network 8, and power company 10. Power company 10 may include customer data management system 12, capable of outputting demographic change reports 14. For exemplary purposes, system 2 may represent a power company and its customers. However, example techniques of this disclosure may be readily applied to various other service providers, such as a telecommunications provider, an internet service provider, a water provider, or other type of utility provider.

In the example of FIG. 1, households 4 may be customers of power company 10. Households 4 may, in various examples, represent residential houses, apartments, commercial buildings, industrial factories, farms, warehouses, restaurants, shopping areas, schools, hospitals, or other facilities. Power company 10 may provide households 4 with access to electricity. Households 4 may each require a subscription or other such contract to be eligible to receive electricity. For instance, power company 10 may have a contract with a representative of household 4A requiring that household 4A periodically pay for all energy consumed within the previous period. When contracting with households 4, power company 10 may obtain contract data from households 4. Contract data may be information about the contract, including a per-unit cost (e.g., in dollars per kilowatt hour (kWh)), a contract duration, a contract type, or other information.

Power company 10 may, with permission of customers, obtain demographic data associated with certain households 4. Demographic data may, for example, include information about customers. Examples of demographic data include the age of customers in households 4, the gender of the customers, the number of customers in households 4, the family status of the customers, the type of customers (e.g., residential, commercial, or industrial), and the occupation of the customers. In some examples, power company 10 may obtain demographic data from customers by periodically requesting such data from the customers. However, this may result in few responses. In other examples, power company 10 may only request demographic data at the time of contracting. In this instance, power company 10 may not receive any subsequent changes or updates to demographic data.

Each of households 4 may be associated with one of smart meters 6. In some examples, smart meters 6 may be electrical meters that record consumption of electric energy (i.e., usage data) by a household. In other examples, smart meters 6 may be any device capable of recording utility consumption rates and transferring that information to a utility company. For instance, smart meters 6 may include network routers with monitoring software or hardware, water consumption meters, telephonic monitoring devices, and other devices used by service provider companies to measure consumption rates. In the example of FIG. 1, usage data may be recorded by smart meters 6 in short intervals, such as an hour or less. For instance, smart meter 6A may, in 30 minute intervals, record the amount of electric energy consumed in the last 30 minutes by household 4A. Smart meters 6 may include functionality to connect to one or more networks in order to transmit and receive information, such as usage data. Smart meters may connect to network 8 and transmit the usage data to power company 10 on a regular basis (e.g., daily).

Network 8 may represent any communication network, such as a packet-based digital network. In other examples, network 8 may represent any wired or wireless network such as the Internet, a private corporate intranet, or a PSTN telephonic network. Network 8 may include both wired and wireless networks as well as both public and private networks. Smart meters 6 and customer data management system 12 may each contain one or more network interface devices for communicating with each other via network 8. For example, smart meter 6A may transmit usage data via a wireless card to a publicly-accessible wide area wireless network. The wide area network may route the usage data to customer data management system 12, within power company 10, via a wired connection.

Customer data management system 12 may store information about customers of power company 10. For instance, customer data management system 12 may store contract data received from households 4, including per-unit cost, contract duration and contract type. Customer data management system 12 may also store demographic data received from households 4, such as number of customers in each household, or familial relationship. Customer data management system 12 may also store usage data received from smart meters 6 via network 8.

Customer data management system 12 and/or power company 10 may use the stored information (i.e., contract data, demographic data, and usage data), in various instances, to provide improved services to customers. That is, power company 10 may improve reliability of service, quality of service, profitability, efficiency, or other metrics, based on analysis of customer information. As one example, power company 10 may use demographic data to target relevant advertising of new products or services to specific households 4. In another example, power company 10 may use usage data and contract data to inform specific households 4 of overage charges or usage limits. Power company 10 may obtain up-to-date usage data and contract data with relative ease. Usage data is regularly received from smart meters 6. Contract data may be updated by customer data management system 12 whenever contracts are entered, modified or terminated. However, demographic data may be more difficult to acquire.

Power company 10 may utilize customer data management system 12 to detect potential changes in demographic data for individual households 4. Techniques of the present disclosure may provide demographic change reports 14 indicating a likely change in demographic data associated with a particular household 4 by analyzing usage data, contract data, and demographic data of a subset of households 4 and comparing the usage data and/or contract data of the particular household 4 to the analyzed data. For example, customer data management system 12 may receive and store usage data from smart meters 6 and contract data from households 4. Customer data management system 12 may also receive demographic data from a subset of households 4. In response to a request from a user (e.g., an employee of power company 10) to create a prediction model, customer data management system 12 may create the prediction model by analyzing the received usage data, and separating the usage data into groups, or clusters based on received demographic data. That is, customer data management system 12 may break the usage data into subsets defined within a multidimensional space. Customer data management system 12 may then use known changes in the demographic data (e.g., a household reporting an increase in occupancy) and/or contract data to group the subsets of usage data based at least in part on the likeness between each subset and on each subset's relationship with the known changes. The groups, or clusters of subsets may each be stored as part of a prediction model by data management system 12.

Customer data management system 12 may utilize the stored prediction model to detect potential changes in demographic data and output demographic change reports 14 based on the detected changes. Customer data management system may, for example, receive a request from an employee of power company 10 to analyze usage data of a particular household. In response to the request, customer data management system 12 may break the usage data of the particular household into subsets each defined within the multidimensional space. Customer data management system 12 may then compare each subset to each of the clusters of usage data in the prediction model to determine which subsets of usage data of the particular household most closely align to which clusters of the prediction model. Based on this comparison, the customer data management system 12 may determine that the demographic data of the household likely changed, and may output one or more demographic change reports 14 based on this determination. In some examples, the demographic change reports 14 may be based on other information, such as instructions provided by users of customer data management system 12, contract data of the customers, or other data.

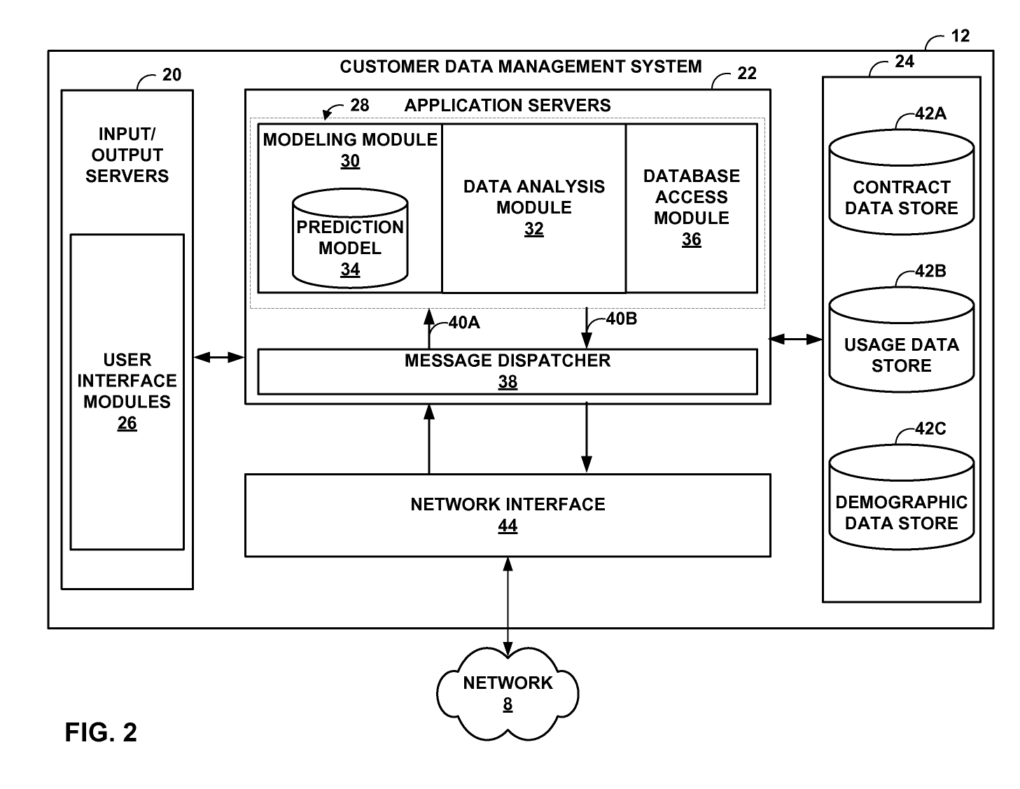

In this way, customer data management system 12 may provide power company 10 with the ability to more accurately maintain up-to-date demographic data of its customers by analyzing the usage data of customers. That is, customer data management system 12 may allow power company 10 or various other service providers to more efficiently detect demographic changes by using previous usage data, contract data, and demographic data. Consequently, customer data management system 12 may enable utility companies and service providers to more accurately target mailings and/or other customer communications based on demographic data. Further details of customer data management system 12 are described with respect to FIG. 2 below.

FIG. 2 is a block diagram illustrating further details of one example implementation of customer data management system 12 illustrated in FIG. 1, in accordance with one or more aspects of the present disclosure. Customer data management system 12 may receive usage data from smart meters 6 and may receive contract data and demographic data from a subset of households 4 (e.g., from customers themselves or via employees of power company 10). In order to maintain more up-to-date records of demographic data for households 4, customer data management system 12 may create a prediction model, analyze usage data to detect unreported changes in demographic data, and output demographic change reports 14.

In general, customer data management system 12 includes one or more computing devices (e.g., computing servers that provide operating environments for various software modules). These servers can generally be categorized as input/output (IO) servers 20, application servers 22, and database servers 24. Although these servers are illustrated separately in FIG. 2, customer data management system 12 may, in various examples, be realized by a single computing device or a plurality of cooperating computing devices, as the case may be.

IO servers 20 provide an interface by which one or more users (e.g., employees or administrators of power company 10, affiliates of power company 10, or other commercial vendors) may communicate with customer data management system 12. In some examples, IO servers 20 may be web servers that execute web server software. As such, IO servers 20 may provide an environment for interacting with remote data and applications according to user interface modules 26, which can include Active Server Pages, web pages written in hypertext markup language (HTML) or dynamic HTML, Active X modules, Lotus scripts, Java scripts, Java Applets, Distributed Component Object Modules (DCOM) and the like. In other examples, IO servers 20 may be servers capable of establishing a connection to employees via a corporate intranet, or public network (e.g., via a virtual private network connection) and transferring information. Although illustrated as “server side” software modules executing within an operating environment provided by IO servers 20, user interface modules 26 could readily be implemented as “client side” software modules executing on computing devices used by one or more remote users, such as those of employees of power company 10.

Network interface 44 provides various interfaces and/or modules that provide the ability to establish connections with one or more remote devices, such as smart meters 6. As shown in FIG. 2, network interface 44 may enable customer data management system 12 to communicate over network 8. In this manner, customer data management system 12 can automatically interact with smart meters 6 (e.g., receive recorded customer data) and/or other systems deployed at various locations.

Application servers 22 provide an operating environment for application software modules 28, which provide the underlying logic and functionality for implementing the various techniques ascribed to customer data management system 12 herein. Message dispatcher 38 receives communications from other components associated with customer data management system 12, such as network interface 44 or IO servers 20, and issues inbound messages 40A to application software modules 28 to process the communications. In particular, network interface 44 may receive communications from remote devices (e.g., usage data from one or more of smart meters 6 or demographic data from IO servers 20), and, in turn, forward the communications to message dispatcher 38. Message dispatcher 38 determines the appropriate application software modules 28 for processing each communication, and dispatches one or more inbound messages 40A to the identified modules. In a similar manner, application software modules 28 may generate outbound messages 40B to communicate with remote devices or users via network 8 or IO servers 20.

Application software modules 28 may include a number of modules including modeling module 30, data analysis module 32 and database access module 36. Application software modules 28 interact with database servers 24 to access a number of data stores 42, including contract data store 42A, usage data store 42B, and demographic data store 42C. Data stores 42 may be implemented in a number of different forms including data storage files, or as a database management system (DBMS). The database management system may be a relational (RDBMS), hierarchical (HDBMS), multidimensional (MDBMS), object oriented (ODBMS or OODBMS) or object relational (ORDBMS), or other database management system. Furthermore, although illustrated separately, data stores 42 could be combined into a single database or other data storage structure. Data stores 42 could, for example, be implemented as a single relational database (such as that marketed by Microsoft® Corporation under the trade designation ‘SQL SERVER”).

Data stores 42 may each include data pertaining to customer households 4 of power company 10. For example, contract data store 42A may contain a record associated with household 4A indicating the type, duration, and per unit price information of the contract household 4A is bound by. Usage data store 42B may contain one or more records of usage data received from smart meter 6A, associated with household 4A. Demographic data store 42C may store a historical record of demographic information associated with household 4A, such as number of occupants in household 4A. In other words, for various ones of households 4, each of contract data store 42A, usage data store 42B, and demographic data store 42C may store current information relating to the household as well as previous information.

Database access module handles and/or processes receipt, storage, and retrieval of data received from various sources, such as from IO servers 20 or network interface 44. For instance, database access module 36 may receive, as part of inbound messages 55A, an identification of usage data entered by a particular one of smart meters 6. In turn, database access module 36 may access database servers 24 and create a record within usage data store 42B to log the received usage data. The record may, for example, specify: (1) a timestamp for the record at which the usage data was received, (2) a number of pairs of measurement times and values, and (3) an identifier for the smart meter from which the data was received. In one example, database access module 36 may receive, as part of inbound messages 40A, an identification of contract data or demographic data entered by a user, such as an employee of power company 10. Database access module 36 may access database servers 24 and create or modify records within contract data store 42A and demographic data store 42C to record the contract data and demographic data, respectively.

Modeling module 30 handles and/or processes instructions to generate or update a prediction model by communicating with database access module 36 to access database servers 24, creating or updating prediction model 34, and providing data analysis module 32 with access to prediction model 34. For instance, modeling module 30 may receive instructions, as part of inbound messages 40A, to create prediction model 34 based on a range of information stored in data stores 42. The instructions may be received by application servers 22 from IO servers 20 (e.g., from an employee of power company 10), or from network interface 44. In other examples, the instructions may be generated regularly by data analysis module 32 and communicated directly to modeling module 30. That is, instructions to create or update prediction module 34 may be generated based on received input or may be generated by components within customer data management system 12. In some examples, modeling module 30 may routinely (e.g., monthly) update or create prediction model 34 for use by data analysis module 32.

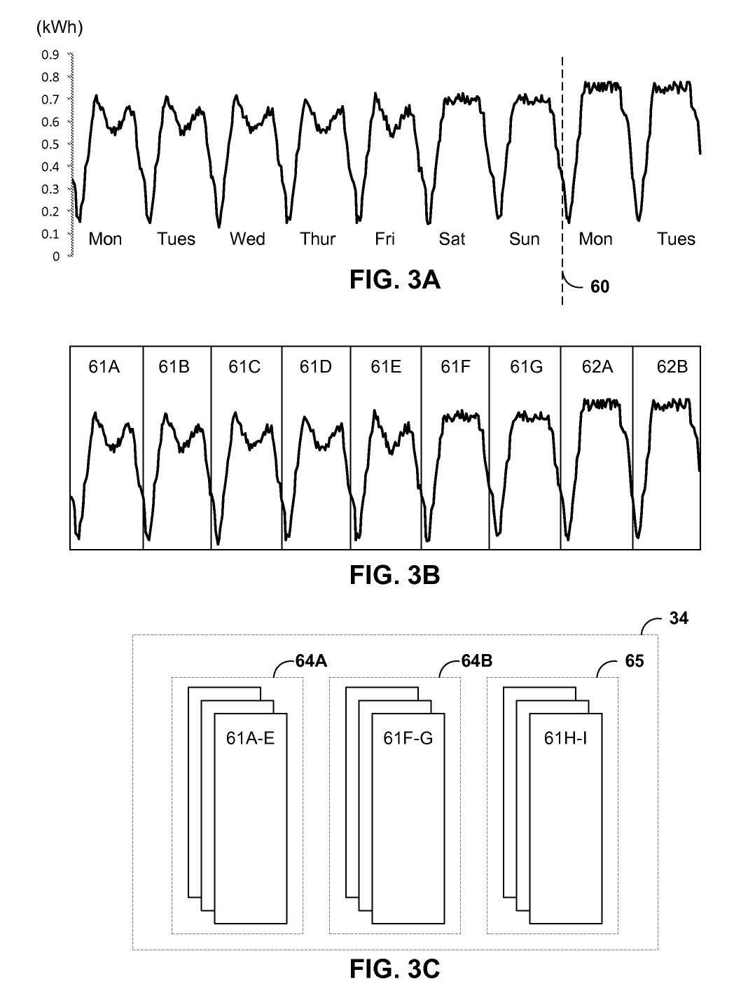

Modeling module 30 may communicate with database access module 36 to retrieve relevant data from data stores 42. In some examples, modeling module 30 may compare data retrieved from usage data store 42B with data retrieved from demographic data store 42C to determine prediction model 34. For instance, modeling module 30 may obtain known changes in the demographic data of a household (e.g., a household 4B) from data stores 42 and separate the corresponding usage data for household 4B (i.e., data received from a smart meter 6B) into usage data measured before the known change, and usage data measured after the known change. Modeling module 30 may further separate the usage data of household 4B into subsets, define groups based on the subsets, and associate each subset with a defined group. That is, modeling module 30 may map the subsets of the usage data to one or more groups, or clusters. In this way, modeling module 30 may create patterns, or models, of the clustered usage data subsets (i.e., collectively prediction model 34), each cluster having various attributes. Modeling module 30 is further described with respect to FIG. 3 below.

Data analysis module 32, in various implementations, processes instructions to analyze usage data by employing prediction model 34. Based on the analysis, data analysis module 32 may output one or more demographic change reports 14 indicating a potential change in demographic data associated with a household. For example, data analysis module 32 may receive, as part of inbound messages 40A, instructions to analyze usage data stored in usage data store 42B (e.g., values of energy consumption measured by smart meter 6A). The instructions may be automatically generated, or may come from a user (e.g., employees or administrators of power company 10). The instructions may include parameters such as an indication of the usage data to analyze, an action to take in response to a detected potential change, and/or types of potential changes to consider.

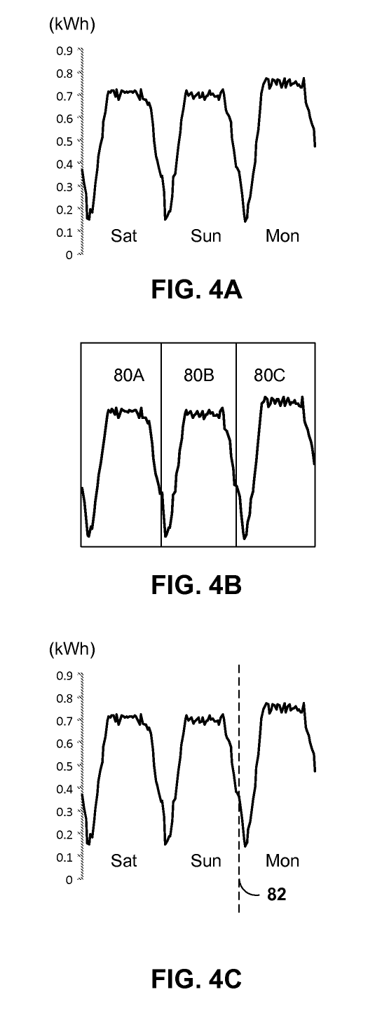

In response to receiving the analysis instructions, data analysis module 32 may communicate with database access module 36 to access usage data store 42B and retrieve usage data. Data analysis module may separate the retrieved usage data for each of households 4 into a number of subseries, and compare the subseries to the clusters of prediction model 34. In accordance with the techniques described herein, data analysis module 32 may determine that a potential change has likely occurred in the demographics of household 4A based on the comparison. In other words, data analysis module 32 may use prediction model 34 and usage data recorded by smart meters 6 to detect that a potential change has likely occurred in a household's demographics. Further details of data analysis module 32 are described with respect to FIG. 4 below.

In response to detecting that a potential change has likely occurred in the demographics of a household, data analysis module 32 may output, as part of outgoing messages 40B, an indication of a demographic change report. A demographic change report may include information regarding a recommended change in demographic data for a specific one of households 4. For example, the change message may contain an indication of the household the demographic data of which is to be changed, the time the recommended change was determined to have happened, the certainty of the recommended change, the type of change recommended, and the like.

Message dispatcher 38 may communicate the demographic change report to other components of customer data management system 12, such as network interface 44 or IO servers 20. In one example, application servers 22 may communicate with IO servers 20 to relay the demographic change report, and IO servers 20 may output the demographic change report via user interface modules 26 to one or more users, such as employees of power company 10. In some examples, demographic change reports may be outputted as the potential changes are determined. That is, a demographic change report may be outputted immediately. In other examples, demographic change reports may be stored and outputted later. For instance, demographic change reports corresponding to potential changes may be outputted regularly (e.g., daily, weekly) for review, or may be outputted in response to a request from a user. A user may then review the demographic change report, and accept or reject the suggested change in demographic data. In other examples, network interface 44 may automatically update demographic data store 42C to reflect the detected potential change, and or send demographic change reports 14 via network 8 to partner companies or other organizations affiliated with power company 10.

Detecting changes in customer demographic data and updating demographic data store 42B may enable power company 10 to provide targeted customer communications. For instance, customer data management system 12 may alert an advertising server, email server, advertising partner, or other system of the change in demographic data. The advertising server, for example, may then generating a mailing to the customer whose demographic data has changed.

FIGS. 3A, 3B and 3C are block diagrams illustrating an example process for mapping usage data, in accordance with one or more aspects of the present disclosure. The process of FIGS. 3A, 3B and 3C may, for instance, be performed by modeling module 30 to create prediction model 34, as described in FIG. 2. FIG. 3A includes a data graph, as well as known change 60. The graph displayed in FIG. 3A may represent usage data received from one of smart meters 6 (e.g., smart meter 6B) over a period of nine days (i.e., from a Monday through the Tuesday of the following week). The usage data may consist of data points recorded in 30 minute intervals throughout each day, with each data point representing a measurement of the energy consumption (in kWh) of household 4B over the past 30 minutes. The usage data of FIG. 3A may be received by customer data management system 12 incrementally (e.g., daily) via network 8 and stored in usage data store 42B in accordance with techniques of the present disclosure.

Known change 60 may represent a change in demographic data or contract data associated with household 4B. For instance, prior to known change 60, demographic data associated with household 4B may have indicated an occupancy of one family, consisting of two people. Subsequently, an employee of power company 10 may, for example, receive a phone call, an email, or some other indication that the family in household 4B just had a child on the Sunday shown in FIG. 3A. In response to receiving the indication, power company 10 may record the updated demographic data in customer data management system 12. Consequently, customer data management system 12 may determine the existence of known change 60.

In accordance with techniques of the present disclosure, modeling module 30 may receive instructions to create prediction model 34. In some examples, modeling module 30 may generate prediction model 34 automatically after a certain amount of time has passed since the last prediction model was generated, such as monthly or quarterly. In other examples, users of customer data management system 12, such as employees or administrators of power company 10, may force creation of prediction model 34 by inputting instructions via IO servers 20. In any case, responsive to receiving instructions to create prediction model 34, modeling module 30 may retrieve the relevant usage data and demographic data from database servers 24.

For ease of understanding, modeling module 30 may create prediction model 34 based only on the usage data of household 4B displayed in the graph of FIG. 3A, as well as known change 60. In various examples, however, modeling module 30 may create a prediction model based on much larger amounts of data, including usage data for multiple households 4 spanning months or years, as well as multiple known changes. Modeling module 30 may retrieve the usage data as shown in FIG. 3A, as well as known change 60.

Modeling module 30 may use various data analysis techniques to create prediction model 34. Such techniques may include principle component analysis, wavelet transforms or Fourier transforms, k-means clustering, hierarchical clustering, and other methods. As one example technique, modeling module 30 may use a simple method of hierarchical clustering as described below in order to create prediction model 34.

From the usage data shown in FIG. 3A, modeling module 30 may separate the usage data based on the occurrence of known change 60. That is, modeling module 30 may split the usage data into that data recorded before the known change and that data recorded after the known change. Modeling module 30 may separate each of the two sets of usage data into equally-sized subseries. The size of the subseries in both sets may be specified in the instructions received by modeling module 30, or may be a default value stored by modeling module 30. Example sizes may include one day's worth of usage data (e.g., 48 data points), one week's worth of usage data (e.g., 336 data points), a certain month's worth of usage data, or other size.

FIG. 3B illustrates usage data of FIG. 3A after modeling module 30 has logically partitioned the usage data into subseries 61A-61G (collectively “subseries 61”), and subseries 62A, 62B (collectively “subseries 62”). In this example, each of the subseries represents a day's worth of usage data. That is, each of subseries 61 and each of subseries 62 may contain 48 points of data. Each data point contains a time-value and an energy consumption value. Modeling module 30 may proceed to construct a multi-dimensional data structure having a plurality of clusters positioned within a multi-dimensional data space, and map the subseries within each set to a number of clusters. In order to provide models correlating to both before and after known change 60, modeling module may maintain the separation of subseries 61 and subseries 62 throughout the mapping process.

As an example technique performed on subseries 61, modeling module 30 may initially assign each of subseries 61 to its own cluster. Modeling module 30 may then employ an iterative process to combine clusters of sufficiently-alike subseries. For instance, modeling module 30 may treat each 30 minute intervals of a subseries as a dimension in a multidimensional Euclidian space. For each possible pair of clusters (i.e., 61A and 61B, 61A and 61C, . . . , 61F and 61G), modeling module 30 may calculate the Euclidian distance between the two clusters. As an example, given the two subseries 61A and 61B, modeling module 30 may calculate a distance, D, between the two:

D=\sqrt{Σᵢ₌₁ⁿ|61Aᵢ−61Bᵢ|},

where i represents a time value of the data points of a subseries and 61Aᵢ and 61Bᵢ are energy consumption values at time i for the respective subseries.

After calculating the Euclidian distance for each pair of subseries, modeling module 30 may determine the respective pair of clusters having the smallest distance, and combine the two clusters. For instance, modeling module 30 may determine that subseries 61A and 61B have the smallest Euclidian distance, and combine the respective clusters to form a single cluster.

After combining two clusters, modeling module 30 may average the energy consumption values of the subseries contained, in order to determine representative values for the newly-formed cluster. For instance, after combining the clusters containing subseries 61A and 61B, modeling module 30 may define a representative subseries, R, for the cluster by averaging 61A and 61B. That is, for each time value, i, in the subseries,

$${R}_{i} = \frac{61 {A}_{i} + 61 {B}_{i}}{2}$$

This process of distance calculation, cluster consolidation, and representative subseries definition may be repeated, in order to map the subseries to appropriate clusters. Modeling module 30 may use the defined representative subseries R for the newly-formed cluster in a next iteration. For instance, the cluster containing subseries 61A and 61B may be represented by subseries R, and modeling module 30 may once again determine the Euclidian distance between the subseries of each cluster. Upon determining the two clusters which are the least distance apart, modeling module 30 may combine the clusters and calculate a representative subseries. In the event that the new cluster includes three subseries (e.g., if the newly formed cluster in the last round is combined with another cluster), the values for the representative subseries will be the average of the three contained subseries. A new cluster that includes four subseries would have a representative subseries defined as the average of the four contained subseries, and so on.

Modeling module 30 may perform the same or similar procedures on the set of subseries 62. In some examples, the iterative clustering processes may repeat until the smallest distance between any two subseries is greater than a threshold value. The threshold value may be defined in the instructions communicated to modeling module 30, or may be predetermined values stored by modeling module 30. In other examples, the clustering processes may be terminated based on criteria such as number of iterations, number of resulting clusters, or a maximum cluster size. In the example of FIGS. 3A, 3B, and 3C, subseries 61A-61E all exhibit a similar energy usage pattern throughout the day. Subseries 61F and 61G are likewise similar. With respect to the usage data after known event 60, subseries 62A and 62B also exhibit a similar energy usage pattern. Initial clusters containing each of these subseries may be iteratively merged by modeling module 30.

FIG. 3C includes three resulting clusters: pre-change cluster 64A, pre-change cluster 64B and post-change cluster 65. Pre-change cluster 64A, 64B and post-change cluster 65 may result from the clustering process performed by modeling module 30 in accordance with techniques of the present disclosure. In some examples, modeling module 30 may determine more or less clusters. For instance, when performing clustering with usage data from multiple households 4 including multiple known changes, modeling module 30 may create copies of the usage data and define pre-change clusters and post-change clusters for each known change. In other examples, modeling module 30 may not create copies of the usage data and may define each cluster as pre-change or post-change with respect to each known change.

Each of pre-change clusters 64A, 64B and post-change cluster 65 may include a defined representative subseries. The clusters and their respective representative subseries may constitute one example of prediction model 34 shown in FIG. 2. The resultant prediction model 34 may be stored by modeling module 30 and accessible by data analysis module 32 for use in detecting potential changes in demographic data.

FIGS. 4A, 4B, and 4C are block diagrams illustrating an example process for detecting a potential change in demographic data, in accordance with one or more aspects of the present disclosure. The process of FIGS. 4A, 4B, and 4C may, for instance, be performed by data analysis module 32 of FIG. 2 to analyze usage data in accordance with one or more techniques of the present disclosure. FIG. 4A includes a data graph of usage data (measured in kWh) over a period of three days. The graph displayed in FIG. 4A may represent usage data received from one of smart meters 6 (e.g., smart meter 6A). For example, customer data management system 12 may receive usage data from smart meter 6A via network 8, and store the usage data in usage data store 42B.

Data analysis module 32 may receive instructions to analyze stored usage data using prediction model 34. In response to receiving the instructions, data analysis module 32 may retrieve the data to be analyzed from usage data store 42B. For ease of understanding, data analysis module 32 may only analyze three days' worth of usage data received from a single household (e.g., household 4A). In other examples, data analysis module 32 may analyze usage data from multiple households, recorded over multiple weeks or months. In order to analyze the data, data analysis module 32 may separate the retrieved usage data in to a number of subseries, each equal in size to subseries in prediction model 34 (i.e., 48 data points).

FIG. 4B shows the retrieved usage data separated into subseries 80A, 80B, and 80C (collectively “subseries 80”). Data analysis module 32 may perform various statistical analysis techniques to determine which cluster of prediction model 34 is most similar to each of subseries 80. Example statistical analysis techniques can include wavelet analysis, fast subsequence matching, dynamic time warping, and others. As one example technique, data analysis module 32 may determine similarity by calculating Euclidian distances for each pair of model cluster and subseries. That is, treating each time value in a subseries as a dimension in Euclidian space, data analysis module 32 may calculate the distance between the representative subseries of pre-change cluster 64A and subseries 80A, the distance between the representative subseries of pre-change cluster 64A and subseries 80B, and so on. In the specific example of FIG. 4B, data analysis module 32 may calculate a distance value for nine different pairings. Table 1, shown below, represents one example set of calculated distance values.

TABLE 1

| | Cluster 64A | Cluster 64B | Cluster 64C |
|---|---|---|---|
| Subseries 80A | .5187 | .2134 | .4219 |
| Subseries 80B | .5203 | .2012 | .4259 |
| Subseries 80C | .6013 | .4219 | .2501 |

As shown in Table 1, the Euclidian distance between subseries 80A and the representative subseries of pre-change cluster 64A may have a value of 0.5187. The Euclidian distance between subseries 80A and the representative subseries of pre-change cluster 64B and post-change cluster 64C may have values of 0.2134 and 0.4219, respectively. That is, the Euclidian distance between subseries 80A and the representative subseries of cluster 64B may be much shorter than the Euclidian distances between subseries 80A the representative subseries of clusters 64A and 64C. Consequently, data analysis module 32 may determine that subseries 80A is most closely aligned with pre-change cluster 64B. In some examples, data analysis module 32 may only determine alignment between a subseries and a cluster when the distance between the two is smaller than other distances by a threshold value, or a percentage value, or other predefined condition is met.

Data analysis module 32 may determine that subseries 80B is also most closely aligned with pre-change cluster 64B. However, because of the distance values for subseries 80C, data analysis module 32 may determine that subseries 80C is most closely aligned with post-change cluster 64C. That is, subseries 80A, 80B, and 80C are most closely aligned with a pre-change cluster, a pre-change cluster, and a post-change cluster, respectively. Based on the determined alignments, data analysis module 32 may determine a potential change in demographic data associated with household 4A occurred approximately between subseries 80B and subseries 80C.

In some examples, such as where prediction model 34 addresses multiple known changes, alignments determined by data analysis module 32 may determine the type of change in demographic data. For instance, in the example of FIG. 4B, if subseries 80 are each aligned with clusters defined as pre-change with respect to one known change (e.g., a household having an extra occupant), data analysis module 32 may determine that no such change occurred based on the usage data of subseries 80. However, data analysis module 32 may determine that subseries 80A is aligned with a cluster defined as pre-change with respect to a second known change (e.g., a household undergoing renovation) while subseries 80B and 80C are aligned with clusters defined as post-change with respect to the second known change. Consequently, data analysis module 32 may determine that household 4A began undergoing renovation approximately between the time that usage data for subseries 80A was recorded and the time that usage data for subseries 80B was recorded.

FIG. 4C includes a data graph of usage data corresponding to subseries 80. Also shown in FIG. 4C is determined change 82. Determined change 82 may indicate that the demographic data of household 4A, from which usage data for subseries 80 was recorded, changed approximately between the displayed Sunday and Monday. Determined change 82 is based on prediction model 34 including only known change 60 and thus, determined change 82 may also indicate that occupants of household 4A now have a child. In this way, data analysis module 32 may determine changes in demographic data.

Based on a determined change in demographic data, data analysis module 32 may generate a demographic change report in accordance with one or more aspects of the present disclosure. In some examples, the demographic change report may be provided to users, such as employees of power company 10, for acceptance or denial. In other examples, the demographic change report may be provided to other entities, such as other computing devices, administrators, or other entities. If accepted, data analysis module 32 may receive a a confirmation message corresponding to the change. In such case, determined change 82 may be recorded in demographic data store 42C. In other examples, data analysis module 32 may communicate with database access module 36 to automatically record determined change 82 in demographic data store 42C. That is, updating demographic data store 42C may be user controlled, or may be automatic.

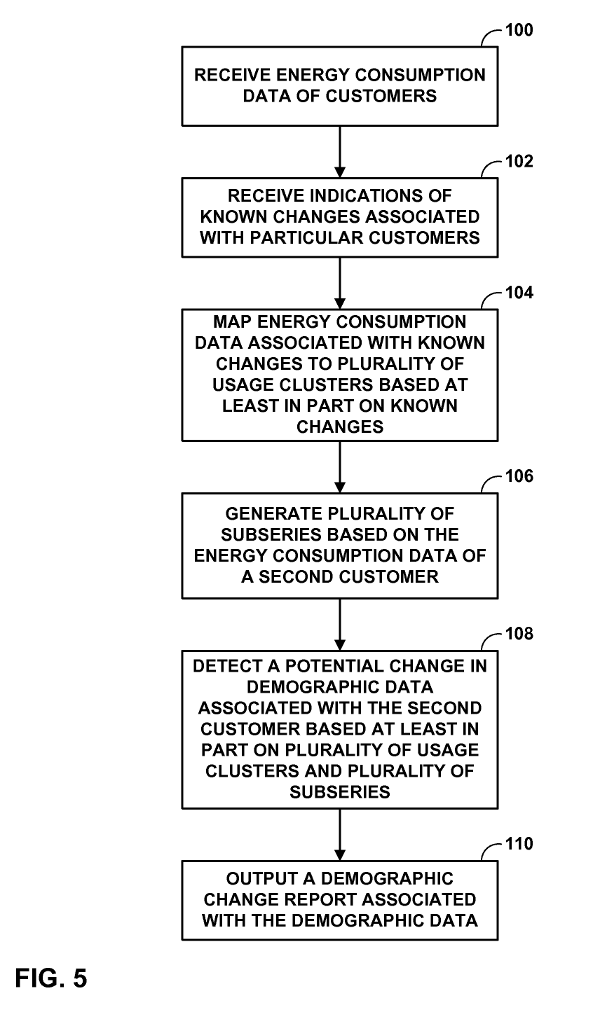

FIG. 5 is a flowchart illustrating an example process for detecting and reporting a potential change in demographic data, in accordance with one or more aspects of the present disclosure. For purposes of illustration only, the example operations are described below within the context of system 2 and customer data management system 12, as shown in FIGS. 1 and 2. In the example of FIG. 5, customer data management system 12 may receive energy consumption data of a plurality of customers (100). Customer data management system 12 may also receive indications of known changes associated with particular customers (102). Based at least in part on the received indications of known changes, customer data management system 12 may map the received energy consumption data associated with the known changes to a plurality of usage clusters defined within a multidimensional space to create a prediction model (104).

Customer data management system 12 may generate a plurality of subseries based on the energy consumption data of, for example, a second customer (106). Based at least in part on the plurality of usage clusters and the plurality of subseries, customer data management system 12 may detect a potential change in demographic data associated with the second customer (108). Customer data management system 12 may output a demographic change report associated with the demographic data, the demographic change report based at least in part on the detected change (110).

In some examples, mapping the energy consumption data associated with a known change to a plurality of usage clusters defined within a multidimensional space may include generating, based on the energy consumption data associated with the known change, a second plurality of subseries, wherein at least one subseries of the second plurality of subseries comprises the energy consumption data associated with the known change that corresponds to a time interval prior to the known change and at least one subseries of the second plurality of subseries comprises the energy consumption data associated with the known change that corresponds to a time interval subsequent to the known change.

In some examples, mapping the energy consumption data associated with the known change to a plurality of usage clusters defined within a multidimensional space may include determining the plurality of usage clusters based on the generated second plurality of subseries. In some examples, the plurality of usage clusters may be determined using hierarchical clustering. In some examples, hierarchical clustering comprises assigning each of the second plurality of subseries to a preliminary cluster, and iteratively calculating distances between each of the second plurality of subseries and merging the two preliminary clusters having the least distance between them, while the least distance is greater than a threshold value.

In some examples, the plurality of usage clusters may be determined using k-means clustering. In some examples, the method of FIG. 5 further includes capturing the energy consumption data of the customer using a smart electricity meter associated with the customer. In some examples, the change in demographic data comprises at least one of: an increase in occupancy of a household of the customer, a decrease in occupancy of the household, a change in at least one occupant of the household, and a change in occupation of the at least one occupant of the household. In some examples, the method of FIG. 5 further includes receiving from a user a confirmation message corresponding to the at least one demographic change report, responsive to receiving the confirmation message, recording the potential change in demographic data to a set of customer data, and generating one or more customer communications based at least in part on the recorded potential change in demographic data.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects of the disclosure have been described. These and other aspects are within the scope of the following claims.

1. A computer-implemented method comprising:
receiving, by a computing device, energy consumption data of a customer, the energy consumption data being generated by an electricity meter associated with the customer;
detecting, by the computing device, based at least in part on demographic data about one or more customers and the received energy consumption data that indicates energy consumption of the customer, a potential change in demographic data about the customer; and
outputting, by the computing device, based at least in part on the detecting, at least one demographic change report associated with the demographic data about the customer, wherein the at least one demographic change report indicates when the potential change in the demographic data about the customer was detected based on the energy consumption data.

2. The method of claim 1, further comprising:
receiving energy consumption data associated with a known change in the demographic data about the one or more customers;
mapping the energy consumption data associated with the known change to a plurality of usage clusters defined within a multidimensional space; and
generating, based on the energy consumption data of the customer, a plurality of subseries, wherein a first subseries included in the plurality of subseries comprises the energy consumption data of the customer that corresponds to a time interval prior to an event and a second subseries included in the plurality of subseries comprises the energy consumption data of the customer that corresponds to a time interval subsequent to the event;
wherein detecting the potential change in the demographic data about the customer comprises determining, based at least in part on the first subseries, the second subseries, and the plurality of usage clusters, that the event corresponds to the potential change.

3. The method of claim 2, wherein determining that the event corresponds to the potential change comprises:
generating a set of values for both the first subseries and the second subseries, wherein each of the values represents the likelihood that the respective subseries belongs to the respective usage cluster; and
comparing the sets of values for the first subseries and the second subseries.

4. The method of claim 2, wherein mapping the energy consumption data to the plurality of usage clusters comprises:
generating, based on the energy consumption data associated with the known change, a second plurality of subseries, wherein at least one subseries of the second plurality of subseries comprises the energy consumption data associated with the known change that corresponds to a time interval prior to the known change and at least one subseries of the second plurality of subseries comprises the energy consumption data associated with the known change that corresponds to a time interval subsequent to the known change; and
determining, based on the generated second plurality of subseries, the plurality of usage clusters in the multidimensional space.

5. The method of claim 4, wherein the plurality of usage clusters is determined using hierarchical clustering.

6. The method of claim 5, wherein using hierarchical clustering comprises:
assigning each of the second plurality of subseries to a preliminary cluster; and
iteratively calculating distances between each of the second plurality of subseries and merging the two preliminary clusters having the least distance between them, while the least distance is less than a threshold value.

7. The method of claim 4, wherein the plurality of usage clusters is determined using k-means clustering.

8. (canceled)

9. The method of claim 1, wherein the potential change in the demographic data about the customer comprises at least one of: an increase in occupancy of a household of the customer; a decrease in occupancy of the household; and a change in at least one occupant of the household.

10. The method of claim 1, further comprising storing a set of customer data, the set containing demographic data about the customer, and energy consumption data associated with the customer.

11. The method of claim 1, further comprising:
receiving a confirmation message corresponding to the at least one demographic change report;
responsive to receiving the confirmation message, recording the potential change in demographic data to a set of customer data; and
generating one or more customer communications, based at least in part on the recorded potential change in demographic data.

12. The method of claim 1, wherein the at least one demographic change report indicates a type of change for the potential change in demographic data associated with the customer.
